(19) United States
(12) Patent Application Publication
(10) Pub. No.: US 2005/0199092 A1
(43) Pub. Date: Sep. 15, 2005

(54) Insert for a bicycle pedal crank, pedal crank comprising such an insert and methods suitable for making such an insert and such a pedal crank

(75) Inventors: Mauri Feltrin, Nanto (Vicenza) (IT); Paolo Dettori, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo, S.r.l., Vicenza (IT)

(21) Appl. No.: 11/074,290

(22) Filed: Mar. 7, 2005

(30) Foreign Application Priority Data
Mar. 5, 2004 (EP) 04425151.0

(51) Int. Cl. G05G 1/14

(52) U.S. Cl. 74/594.1

(57) ABSTRACT

An Insert for a bicycle pedal crank is provided. The insert is made from unidirectional structural fibers incorporated in a polymeric material and coupled according to two distinct directions. The Insert has a connection portion to a part of the bicycle and a fastening portion to the body of the pedal crank.

### FIELD OF THE INVENTION

The present invention refers to an insert for a bicycle pedal crank and to a method suitable for making such an insert.

The invention also refers to a pedal crank incorporating such an insert and to a method for obtaining it.

### BACKGROUND

Different types of pedal cranks are known with different shapes, materials and constructive techniques aimed at achieving the objective of reducing the weight as much as possible and at the same time ensuring, if not even improving, the characteristics of resistance and reliability of pedal cranks.

The tendency towards making lighter pedal cranks has led to the use of composite materials, having a specific weight lower than the specific weight of conventional metal pedal cranks.

Remaining nevertheless unaltered the specific pressures that come into play in the use of pedal cranks in composite material, in the case in point the torsion forces between the chain and the toothed crowns and the torsion forces on the pedal and on the bottom bracket due to the driving action of the cyclist as he/she pedals, it is necessary to ensure an adequate mechanical resistance of the interface zones between the body of the pedal cranks in composite material and the attachment zones to the toothed crowns, the attachment zone to the bottom bracket and the attachment zone to the pin or spindle of the pedal, respectively.

To reinforce such interface zones metallic inserts are used. Such pedal cranks are made by molding of a thermo-setting composite material inside a mold where such metallic inserts are arranged.

The composite material in plastic state is arranged to cover the inserts, surrounding them for a large part of their outer surface. The material thus arranged inside the mold is heated and simultaneously subjected to a suitable pressure until it is reticulated. The pedal crank then undergoes a cooling until it reaches room temperature.

During the cooling step due to the different cooling coefficient, there is the drawback that the composite material that surrounds the metallic insert tends to detach from the walls of the insert itself. During cooling, indeed, the metallic material of which the insert consists shrinks more than the composite material of the pedal crank body and the degree of detachment is all the greater the greater the difference of the cooling coefficient of the two materials. Such a detachment involves a decrease in adherence between the metal insert and the composite material, with a consequent decrease in the properties of resistance and hold of the interface zones.

The purpose of the present invention is that of overcoming said drawback.

### SUMMARY

A first purpose of the invention is to provide an insert for a pedal crank that does not detach and at the same time that ensures sufficient resistance for the interface zones in which it is arranged.

Indeed, studies and research by the Applicant have demonstrated that by giving inserts a particular structure it is possible to make them in composite material.

Another purpose of the invention is to make an insert for a pedal crank that gives the pedal crank itself a lower weight with respect to known pedal cranks with metallic inserts.

A first aspect of the invention lies in an insert for a bicycle pedal crank wherein the insert is made of unidirectional structural fibers incorporated in a polymeric material and coupled according to at least two distinct directions and in that the insert has a connection portion to a part of the bicycle and a fastening portion to the body of the pedal crank.

Advantageously the unidirectional structural fibers coupled according to many directions give the insert a high mechanical rigidity and allow its direct connection to the bicycle parts.

A second aspect of the invention lies in a method for making an insert for a bicycle pedal crank with unidirectional structural fibers incorporated in a polymeric material, coupled according to at least two distinct directions, wherein the method comprises the steps of:
providing a mold;
providing said unidirectional structural fibers incorporated in a polymeric material in sheets;
providing, in said mold, a plurality of sheets piled up so that the unidirectional structural fibers are oriented according to at least two distinct directions;
subjecting the mold to a pressure and temperature profile such as to cause the setting of the polymeric material;
removing the insert from said mold.

Another aspect of the invention lies in a bicycle pedal crank, wherein it comprises a main body at least partially comprising a composite material comprising structural fibers incorporated in a polymeric material and in that the crank comprises one or more of the aforementioned inserts.

A further aspect of the invention lies in a method for making a pedal crank comprising a main body at least partially consisting of a composite material consisting of structural fibers incorporated in a polymeric material, wherein the method comprises the steps of:
providing a mold shaped according to the desired outer profile of the pedal crank;
providing, in at least one predetermined zone of said mold, at least one insert formed from unidirectional structural fibers incorporated in a polymeric material, the fibers oriented in at least two distinct directions, and having a fastening portion and a connection portion;
providing said composite material in the mold;
subjecting said composite material to a temperature and pressure profile such as to allow it to be arranged in contact with the fastening portion of said at least one insert and such as to cause the setting of the polymeric material;
removing the pedal crank from the mold.

### BRIEF DESCRIPTION OF THE DRAWINGS

Further characteristics and advantages of the invention shall become clearer from the description of preferred embodiments, made with reference to the attached drawings, where:

FIG. 1 represents, in an axonometric view, the insert of the invention;

FIG. 2 represents, in an axonometric view, an intermediate product for obtaining the insert of the invention of FIG. 1;

FIG. 3 represents a section plan view of a first variant embodiment of the insert of FIG. 1;

FIG. 4 represents a cross section along the axis III°-III° of the insert of FIG. 3;

FIG. 5 represents, in an axonometric view, another variant embodiment of the insert of the invention;

FIG. 6 represents, in an axonometric view, a further variant embodiment of the insert of the invention;

FIG. 7 represents a partially sectioned plan view of a right pedal crank according to the invention;

FIG. 8 represents a partial section view along the axis VII°-VII° of the pedal crank of FIG. 7;

FIG. 9 represents a partial section view along the axis VIII°-VIII° of the pedal crank of FIG. 7;

FIG. 10 represents an exploded axonometric view of another embodiment of a pedal crank according to the invention.

FIGS. 11 to 18 represent different layers of structural fibers used for the insert.

### DETAILED DESCRIPTION OF THE PREFERRED EMBODIMENTS

### Introduction to the Embodiments

A first aspect of the invention lies in an insert for a bicycle pedal crank wherein the insert is made of unidirectional structural fibers incorporated in a polymeric material and coupled according to at least two distinct directions and in that the insert has a connection portion to a part of the bicycle and a fastening portion to the body of the pedal crank.

Advantageously the unidirectional structural fibers coupled according to many directions give the insert a high mechanical rigidity and allow its direct connection to the bicycle parts.

In a preferred embodiment, the insert is made by piling up many sheets of unidirectional fibers in which each sheet consists of unidirectional fibers woven together to make a typical fabric structure with warp and weft.

Again in a preferred embodiment, the insert has a substantially elongated shape along a main axis, in which the fastening portion is contiguous to the connection portion along such an axis. Preferably, the length of the connection portion is slightly greater than the length of the fastening portion.

In a second preferred embodiment, the insert has a substantially tubular shape in which the connection portion is defined on the inner surface of the tubular body and the fastening portion is defined on the outer surface of the tubular body.

Preferably, the insert of the invention has, in the connection portion, a through hole, possibly threaded, to allow the connection to the parts of the bicycle, like for example the toothed crowns, the spindle of the pedal or the spindle of the bottom bracket.

A second aspect of the invention lies in a method for making an insert for a bicycle pedal crank with unidirectional structural fibers incorporated in a polymeric material, coupled according to at least two distinct directions, wherein the method comprises the steps of:
providing a mold;
providing said unidirectional structural fibers incorporated in a polymeric material in sheets;
providing, in said mold, a plurality of sheets piled up so that the unidirectional structural fibers are oriented according to at least two distinct directions;
subjecting the mold to a pressure and temperature profile such as to cause the setting of the polymeric material;
removing the insert from said mold.

In a preferred embodiment of the method, a further step of making a through hole in the connection zone of the insert is provided.

Another aspect of the invention lies in a bicycle pedal crank, wherein it comprises a main body at least partially comprising a composite material comprising structural fibers incorporated in a polymeric material and in that the crank comprises one or more of the aforementioned inserts.

In a preferred embodiment, the main body of the pedal crank entirely comprises the composite material comprising structural fibers incorporated in a polymeric material.

Preferably the polymeric material of the composite material of the body of the pedal crank is substantially the same as the polymeric material that incorporates the unidirectional fibers of the inserts.

Even more preferably, the inserts are inserted in attachment zones that attach the pedal crank at least one the toothed crown, in the attachment zone to the bottom bracket and in the attachment zone to the spindle of the pedal so as to make a pedal crank completely in composite material.

A further aspect of the invention lies in a method for making a pedal crank comprising a main body at least partially consisting of a composite material consisting of structural fibers incorporated in a polymeric material, wherein the method comprises the steps of:
providing a mold shaped according to the desired outer profile of the pedal crank;
providing, in at least one predetermined zone of said mold, at least one insert formed from unidirectional structural fibers incorporated in a polymeric material, the fibers oriented in at least two distinct directions, and having a fastening portion and a connection portion;
providing said composite material in the mold;
subjecting said composite material to a temperature and pressure profile such as to allow it to be arranged in contact with the fastening portion of said at least one insert and such as to cause the setting of the polymeric material;
removing the pedal crank from the mold.

Moreover, the choice of polymeric materials that are substantially the same for the composite material of the body of the pedal crank and for the sheets of unidirectional fibers of the inserts, allows an ideal fastening and therefore a high adherence between the body of the pedal crank and the inserts to be obtained.

Preferably, the through hole in the connection zone of the insert is made after the pedal crank is removed from the mold, to allow the exact centering of the hole itself with respect to the bicycle part intended to be connected to the pedal crank, in particular during the assembly step of the toothed crowns to the pedal crank.

### Description of the Embodiments

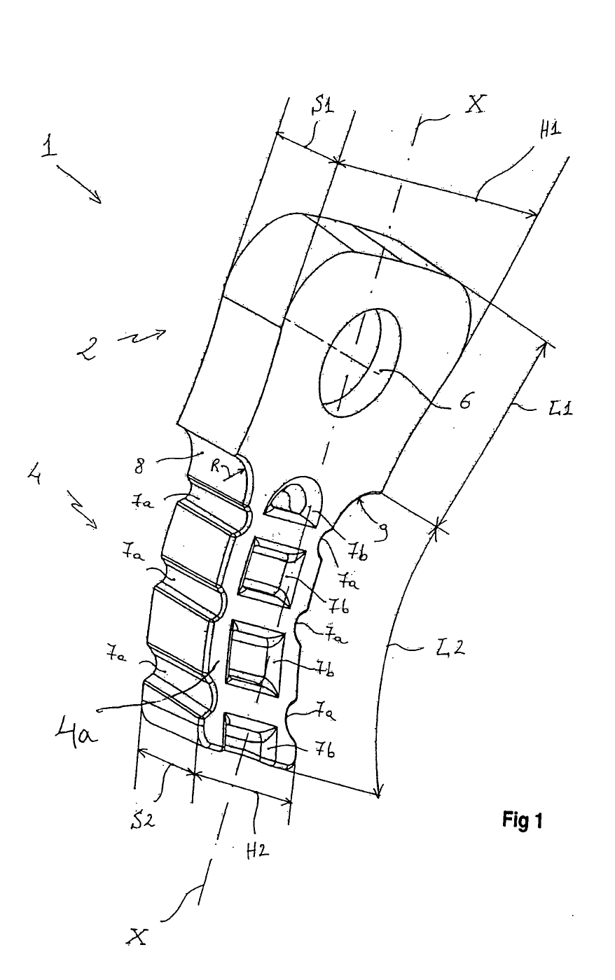

The insert of the invention is represented in FIG. 1 and is wholly indicated with 1.

The insert 1 has an elongated slightly arched shape and extends along the main axis X-X. It essentially consists of a connection portion 2 and a fastening portion 4 that extend contiguously along the main axis X-X.

The fastening portion 4 of the insert 1, has, in its outer surface, a plurality of depression zones 7a, 7b. More specifically, first depression zones 7a extend on the outer peripheral surface of the fastening portion 4 for all of its thickness S2 and consist of substantially cylindrical surfaces. Second depression zones 7b engage the interfacing surfaces 4a and 4b of the fastening portion 4 and consist of cuts that partially engage the thickness S2 of the fastening portion 4 itself. In different embodiments, such depressions 7b could, nevertheless, engage the fastening portion 4 for all of its thickness S2, substantially making through holes.

The connection portion 2 has a through hole 6.

The fastening portion 4 has a length L2 slightly greater than the length L1 of the first portion 2, whereas its width H2 is less than the width H1 of the first portion. The thicknesses S1 and S2 of the connection and fastening portions 2 and 4, on the other hand, are substantially the same.

The connection and fastening portions 2 and 4 are connected through two surfaces 8 and 9 having a circular profile of radius R. The curvilinear progression of such surfaces allows the tensions to which the insert 1 is subjected in the transition zone between the connection and fastening portions 2 and 4 to be uniformly distributed. The value of the radius R is suitably chosen, in the design phase, based upon the force components to which the insert 1 is subjected.

The insert 1 is made through the piling up of many sheets of unidirectional structural fibers incorporated in a polymeric material coupled together according to two distinct directions.

In a first embodiment, the unidirectional structural fibers are oriented according to two perpendicular directions and are woven together to define the weft and the warp of a sheet of fabric, commonly known as plain fabric. The insert 1 is thus obtained through the piling up of a number of sheets of fabric in a sufficient number to reach the desired thickness S1 (S2).

The sheets of fabric used typically have a thickness of between 0.3 and 0.5 mm whereas the thickness S1 (S2) of the insert 1 is in the order of 5 mm, thus, between 10 and 17 sheets of fabric are used.

The fabric obtained from the weaving of unidirectional fibers of warp and weft can have, in different embodiments, any known weave, like for example a “twill” or “satin” fabric.

Preferably, but not necessarily, the weft fibers are present in the fabric with the same percentage by weight of the warp fibers.

In a second preferred embodiment, the unidirectional structural fibers are incorporated in distinct sheets, each containing fibers oriented in a single direction. The insert 1 is obtained by piling up a plurality of such sheets, arranging them so that the directions of the unidirectional fibers that they incorporate do not all coincide. In a preferred way, the sheets of unidirectional fibers are piled up so that the unidirectional fibers are aligned according to two directions perpendicular to each other. In other cases, the sheets of unidirectional fibers are piled up and angularly staggered according to many directions, so as to define a substantially isotropic structure with unidirectional structural fibers distributed on many directions.

In further embodiments, the insert 1 is made by piling up many sheets of the type described above according to any combination, like for example sheets of fabric alternated by sheets of just unidirectional fibers angularly staggered from each other.

In further embodiments, the insert is made of unidirectional structural fibers and of randomly arranged structural fibers incorporated in a polymeric material. In further embodiments, the insert is made of unidirectional structural fibers incorporated in a polymeric material and of randomly arranged structural fibers. Typically, the structural fibers are chosen from the group consisting of carbon fibers, glass fibers, aramidic fibers, ceramic fibers, boron fibers and combinations thereof, carbon fiber being preferred.

The polymeric material can consist of a thermo-setting plastic material or a thermoplastic material, with different known treatment processes according to the chosen material, as we shall see later on.

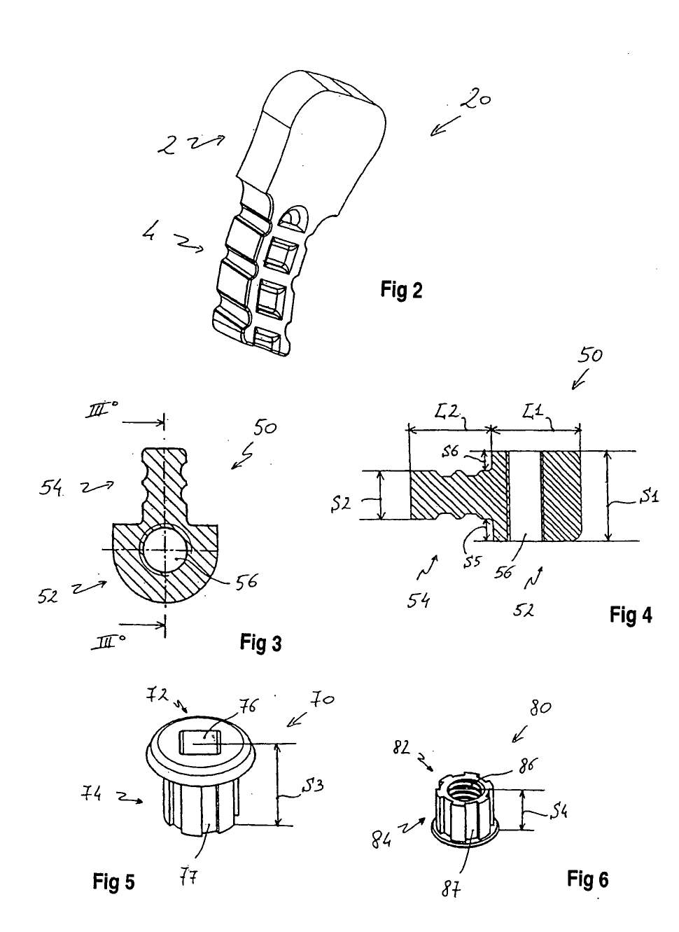

In FIG. 2 a variant embodiment of the insert 20 is represented that differs from the embodiment described previously in that it does not have the through hole 6 in the connection portion 2.

In FIGS. 3 and 4 a variant embodiment of the insert is represented, indicated with 50. The insert 50 differs from the insert described with reference to FIG. 1 in that it has the connection portion 52 with a thickness S1 greater than the thickness S2 of the fastening portion 54 and, moreover, the hole 56 in the connection portion 52 is threaded.

The thickness S1 of the insert 50 is in the order of 14 mm, whereas the thickness S2 is about half the thickness S4, i.e. about 7 mm. The sheets of fabric used, as stated, typically have a thickness of between 0.3 and 0.5 mm, thus to obtain the desired thicknesses S1 and S4 between 14 and 23 sheets of fabric for S3 and between 28 and 46 sheets of fabric for S4 are used, respectively.

In FIG. 5 another variant embodiment of the insert is represented, indicated with 70.

The insert 70 has a substantially tubular shape in which a connection portion 72 and a fastening portion 74 are defined. The connection portion 72 consists of a square hole 76 formed on the inner surface of the tubular body, whereas the fastening portion 74 consists of depressions in the form of grooves 77 that extend on the outer surface of the tubular body for almost the entire thickness S3 of the insert 70, of about 22 mm.

In FIG. 6 a further variant embodiment of the insert is represented, indicated with 80.

The insert 80 has a substantially tubular shape in which a connection portion 82 and a fastening portion 84 are defined. The connection portion 82 consists of a threaded hole 86 coinciding with the inner surface of the tubular body, whereas the fastening portion 84 consists of depressions 87 in the form of grooves that extend on the outer surface of the tubular body for almost the entire thickness S4 of the insert 80, of about 14 mm.

In a particularly preferred way, the insert 1, 20, represented in FIGS. 1 and 2 according to the present invention, is made with the method described hereafter.

In a first semi-mold or mold half shaped according to the outer profile of the insert 1, 20 a predetermined number of sheets of fabric are piled up so as to fill the mold for the desired thickness. Each sheet of fabric is formed of unidirectional structural fibers of carbon fiber, crossed according to two directions, of warp and weft, perpendicular to each other in a configuration commonly known as “plain”. The fabric is arranged in the mold so that one of the two warp and weft directions is substantially parallel to the main axis X-X of the insert 1, 20. The fibers in the sheets of fabric are impregnated with a thermo-setting resin. The mold is then closed through a second mold half that couples with the first mold half to internally define a chamber with a shape matching the outer shape of the insert 1, 20. The two mold halves are then subjected to a temperature and pressure profile such as to cause the cross-linkage of the thermo-setting resin giving the sheets of fabric the compact structure with the desired shape of insert. More specifically, the temperature of the thermo-setting resin is raised from a room temperature value, when the sheets of fabric are positioned in the mold and the resin possesses a degree of plasticity such as to allow the cascade of the sheets of fabric, up to its cross-linkage temperature, i.e. when it takes up a rigid structure. With cross-linkage complete, the insert is left to cool and is then removed from the mold.

The unidirectional fibers can also be incorporated in a thermoplastic resin. In this case the temperature and pressure profile firstly provides that the temperature of the thermoplastic resin be raised from a room temperature value, when the sheets of fabric are positioned in the mold and the resin is substantially rigid, up to its vitreous transition temperature. At such a temperature, the thermoplastic resin of the various sheets of fabric melts, giving a plastic consistency to the piled up sheets of fabric that take up, under pressure, the shape of the mold. What follows is a second cooling step of the mold during which the thermoplastic resin, cooling down, regains the desired rigidity. The mold is then opened and the insert is removed.

In the rest of the present description and in the subsequent claims, with the term “setting” we therefore mean the cross-linkage process when a thermo-setting resin is used, whereas we mean a melting followed by cooling process when a thermoplastic resin is used.

The steps of the method described up to here allow an insert 20 of the type shown in FIG. 2 to be obtained, in other words the same element of FIG. 1 with the exception of the fact that it does not have the hole 6. Preferably, the hole 6 on each insert 20, is made after the insert has been inserted in the pedal crank, as we shall see hereafter. Alternatively, the hole 6 can be made on the insert 20 obtained by the previous method through mechanical processing, for example milling, boring or through cutting with a high pressure beam of concentrated water incorporating abrasive particles.

Alternatively, the hole 6 can be obtained directly during the previous molding steps, taking care to suitably perforate the sheets of fabric before their insertion in the mold and thus before the thermal setting treatment of the thermo-setting or thermoplastic resin.

To make the insert 50 represented in FIG. 4, the same method described above can be used, in which the filling step of the mold through the piling up of sheets of fabric firstly provides for arranging a predetermined number of sheets of fabric of length L1 for a thickness S5, then piling a predetermined number of sheets of fabric of length L1+L2 for a thickness S2 and finally piling up a predetermined number of sheets of fabric of length L1 for a thickness S6.

Alternatively, the aforementioned inserts 1, 20, 50, and their variations in thickness, can be obtained starting from a monolithic element, with a substantially parallelepiped shape, consisting of piled up sheets of fabric subjected to the previous molding cycle with setting, on which subsequent mechanical removal operations are carried out to obtain the desired profiles.

In the case in which one wishes to make the inserts 70, 80 of FIGS. 5 and 6, the same method described previously can be used in which the respective through holes 76 and 86 are advantageously made after the removal from the mold of the set material through mechanical processing by milling, by boring or through cutting with a high pressure beam of concentrated water incorporating abrasive particles.

In a different embodiment of the described method, the sheets of structural fibers can have a weave with a different configuration, like for example “twill”, “satin” or other weave types, or else furthermore the fabric can have different percentages of weight between warp and weft.

In another preferred embodiment of the method, each sheet inserted in the mold consists of just unidirectional structural fibers and the desired thickness is obtained by alternately piling up a predetermined number of sheets according to perpendicular directions.

In a further preferred embodiment, each sheet inserted in the mold consists of just unidirectional structural fibers and the desired thickness is obtained by alternately piling up a predetermined number of sheets according to angularly staggered directions, so as to obtain a substantially isotropic structure with unidirectional fibers distributed homogeneously over 360°.

In a further embodiment of the method, it can be provided to insert in the mold unidirectional structural fibers and randomly arranged structural fibers in a polymeric material.

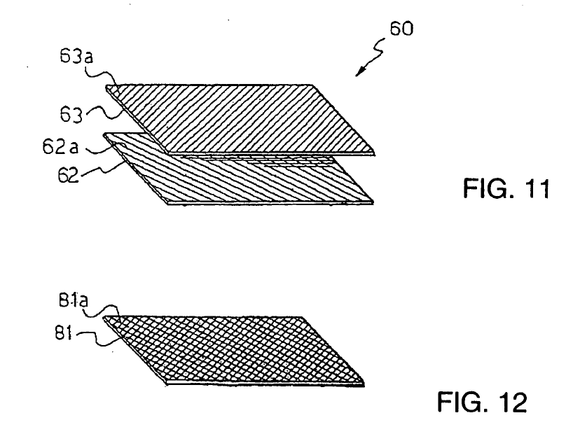

In FIG. 11 two layers 62 and 63 formed of unidirectional structural fibers 62a and 63a incorporated in a matrix of polymeric material and oriented according to directions which are complementary to each other, in particular −45° and +45°.

FIG. 12 represents a layer 81 in which the unidirectional structural fibers 81a are arranged according to two incident directions forming a fabric configuration.

In FIG. 13 three layers are shown. One layer 61, formed of small pieces of structural fiber 61a incorporated in a matrix of polymeric material and randomly arranged inside the layer 61 and two layers 62 and 63 formed of unidirectional structural fibers 62a and 63a incorporated in a matrix of polymeric material and oriented according to directions which are complementary to each other, in particular −45° and +45°.

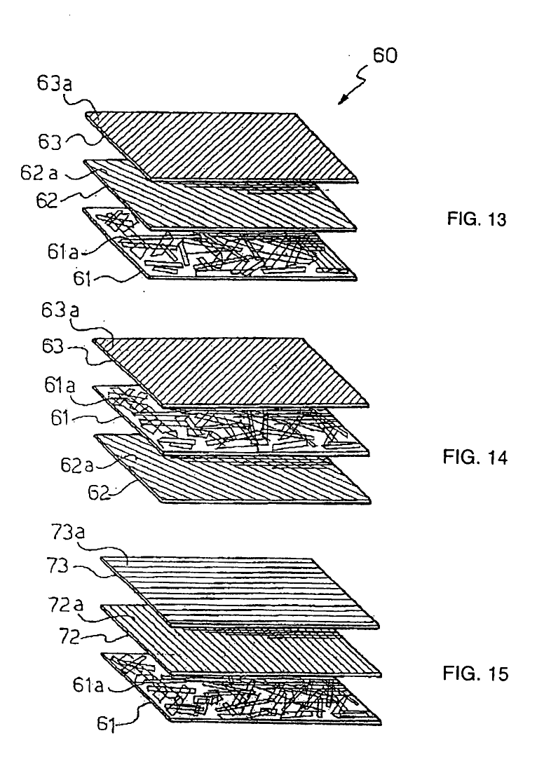

In FIG. 14 the layer 61 is arranged between the two layers 62 and 63.

The embodiment of FIG. 15 differs from that of FIG. 13 in that the unidirectional fibers 72a and 73a incorporated in the matrix of polymeric material of the respective layers 72 and 73 define complementary directions respectively oriented at +90° and 0°.

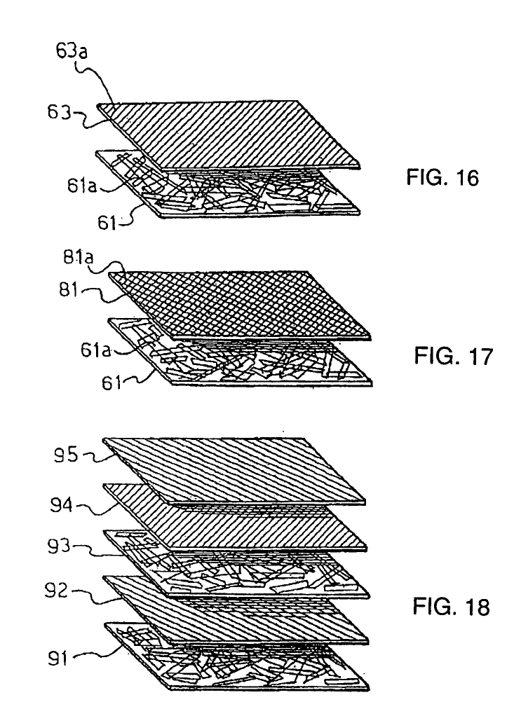

In FIG. 16 a layer of small pieces of structural fibers 61a incorporated in a matrix of polymeric material overlaps a single layer 63 formed of unidirectional structural fibers 63a oriented according to the +45° direction.

In FIG. 17 is represented a layer of small pieces of structural fibers 61a and a layer 81 in which the unidirectional structural fibers 81a are arranged according to two incident directions forming a fabric configuration.

Finally, in FIG. 18 two layers 91 and 93 formed of small pieces of structural fibers incorporated in a matrix of polymeric material are intercalated in three layers 92, 94 and 95 formed of unidirectional structural fibers oriented according to directions chosen between ±45°.

In the embodiments shown in FIGS. 13 to 18, the fibers are incorporated in a respective matrix in all of the layers; alternatively one or more (but not all) of the layers can include only the fibers without any matrix, those fibers becoming incorporated in a matrix of an adjacent layer during molding.

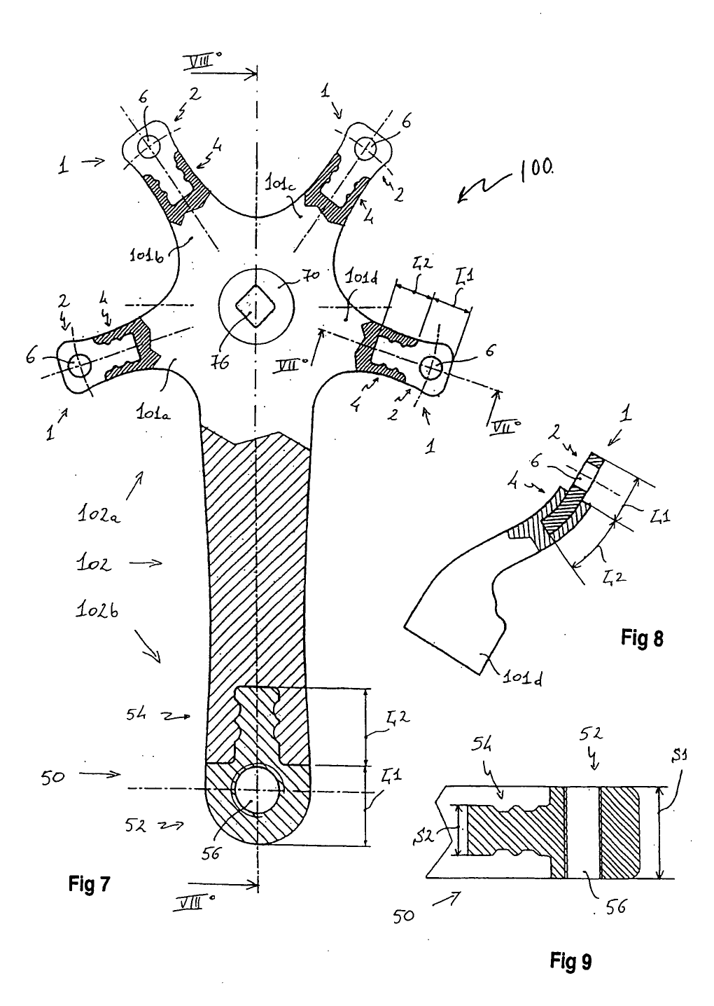

In FIG. 7 a pedal crank with spokes 100 is represented, commonly known as right pedal crank, which connects to the bottom bracket of the bicycle, to the pedal and two or more toothed crowns in mechanical coupling. Such a type of pedal crank 100 substantially has a main body 102 having a first end 102a provided for the connection to the bottom bracket and for the connection of the toothed crowns, not shown, and a second end 102b provided to receive the spindle of a pedal, also not shown.

In the first end 102a of the pedal crank 100, four spokes 101a-101d are made at the ends of which respective inserts 1 or 20 of the type represented in FIG. 1 are inserted. The inserts 1 have the toothed crowns fixed to them, on which the chain is wound for the transmission of the movement from the pedal to the rear wheel. A known attachment method of the toothed crowns to the pedal crank with spokes 100 provides, for example, the use of attachment bolts arranged passing into the holes 6 of the inserts 1 that lock the sprockets to the spokes 101a-101d through corresponding attachment nuts.

As can be seen in the detail of FIG. 8, the fastening portion 4 of each insert 1 is totally enclosed by the material that constitutes the end of the corresponding spoke 101a-101d. In such a configuration, the material that constitutes the pedal crank 100 fills the depressions 7a and 7b of the fastening portion 4, with the consequent increase in contact surfaces and the increase in adherence between the body of the pedal crank and the insert 1. Moreover, the characteristics that the length L2 of the fastening portion 4 incorporated in the body of the pedal crank 100 is greater than the length L1 of the connection portion 2 projecting from the ends of the spokes 101a-101d, allows a high stability of the insert 1, and in particular a high rigidity to be obtained that counteracts possible flexing of the insert along its main axis X-X.

Again in the first end 102a, and in a central position, there is an insert 70 of the type represented in FIG. 5 to the square hole of which 76 the spindle of the bottom bracket is fixed in a known way. The fastening portion 74 of the insert 70, and in particular the grooves 77, are totally enclosed by the material that constitutes the body of the pedal crank 100 determining a high adherence between the body of the pedal crank 100 and the insert 70 itself.

In the second end 102b of the pedal crank 100 there is an insert 50 of the type shown in FIGS. 3 and 4, which allows the connection of a pedal receiving in engagement in the threaded hole 56 the threaded pin of the pedal, not represented. The thickness S1 of the connection portion 52, which is greater than the thickness S2 of the fastening portion 54, allows a smooth progression of the outer surface of the pedal crank 100 to be obtained, promoting the attachment of the pedal to the pedal crank 100 itself.

As observed in FIGS. 7 and 9, the fastening portion 54 of the insert 50 is totally enclosed by the material that constitutes the body of the pedal crank 100, determining a high adherence between the body of the pedal crank 100 and the insert 50 itself. Like for the inserts 1, the stability of the insert 50, and in particular the rigidity with respect to flexing along its main axis X-X, is obtained thanks to the fact that the length L2 of the fastening portion 54 incorporated in the body of the pedal crank 100 is greater than the length L1 of the connection portion 52 projecting from the end of the pedal crank 100.

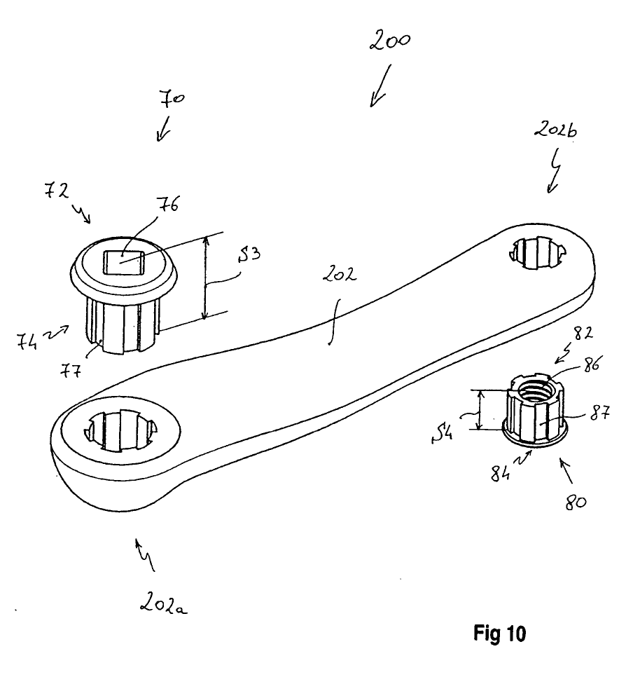

In FIG. 10 a pedal crank 200 is represented, commonly known as left pedal crank, consisting of a main body 202 having a first end 202a provided for the connection to the bottom bracket, not shown, and a second end 202b provided to receive the spindle of a pedal, also not shown.

In a first end 202a of the crank 200 there is an insert 70 of the type represented in FIG. 5, having a square hole 76 that connects to the spindle of a bottom bracket in a known way. The fastening portion 74 of the insert 70, and in particular the grooves 77, are totally enclosed by the material that constitutes the body of the pedal crank 200 determining a high adherence between the body of the pedal crank 200 and the insert 70 itself.

In the second end 202b of the crank 200 there is an insert 80 of the type represented in FIG. 6 having a threaded aperture 86 that connects to the spindle of a pedal in a known way. The fastening portion 84 of the insert 80, and in particular the grooves 87, are totally enclosed by the material that constitutes the body of the pedal crank 200 determining a high adherence between the body of the pedal crank 200 and the insert 80 itself.

In both the described right and left pedal crank 100, 200, the main body 102, 202 advantageously consists of a composite material consisting of structural fibers incorporated in a polymeric material, the fibers of the composite material being able to be arranged in the polymeric material both in a disordered manner, for example in the form of small sheets or pieces of fibers arranged randomly, and in an ordered manner to form a typical fabric structure. The structural fibers, like for the insert, are chosen from the group consisting of carbon fibers, glass fibers, aramidic fibers, ceramic fibers, boron fibers and combinations thereof, carbon fiber being preferred. The polymeric material with which the composite of the pedal crank is made is advantageously chosen of the same type as the polymeric material used to make the inserts 1, 50, 70, 80, in the case in point a thermo-setting resin.

In different embodiments, the right or left pedal crank can provide for the use both of inserts of the type described and inserts of the conventional type made from aluminum or metallic material. For example, such a right pedal crank can have the inserts 1 for the attachment to the toothed crowns of the type described in the present invention, whereas the inserts for the attachment to the bottom bracket and to the pedal can be made from aluminum.

In further different embodiments, the body of the pedal crank can be made not entirely from composite material consisting of structural fibers incorporated in a polymeric material, but have parts of different material or recesses, like for example a hollow metallic core or a core of plastic material. Such bodies are described in patent applications EP 1270393, EP 1270394 and EP 1281609, to the same Assignee of the present invention, the disclosures of which are entirely incorporated herein by reference as if fully set forth.

In a preferred manner, a right or left pedal crank 100, 200 of the type described above, is made with the method described hereafter.

In a first semi-mold or mold half shaped corresponding to the desired outer profile of the pedal crank 100, 200, the inserts 1, 50, 70, 80 are positioned in the corresponding zones relative to the attachment of the toothed crowns (in the case of a right hand crank), to the attachment to the bottom bracket and to the attachment to the spindle of the pedal. Then the composite material that constitutes the body 102, 202 of the pedal crank 100, 200 is arranged in the mold. The mold is then closed through a second mold half that couples with the first mold half to internally define a chamber with a shape matching the outer shape of the pedal crank 100, 200. The composite material is then subjected to a pressure such as to allow it to be arranged to fill the mold and in particular to be arranged in contact with the fastening portion 4, 54, 74, 84 of the inserts 1, 50, 70, 80. The two mold halves are then subjected to a temperature profile such as to cause the setting of the polymeric material that constitutes the composite material of the pedal crank. In particular, if a polymeric material consisting of a thermo-setting resin is used, the temperature of the thermo-setting resin is raised, from a room temperature value, up to its cross-linkage temperature, i.e. when it takes up a rigid structure. The coupling between the composite material and the fastening portions 4, 54, 74, 84 of the inserts 1, 50, 70, 80 is thus made. With setting complete, the pedal crank 100, 200 is left to cool and is then removed from the mold.

If, on the other hand, the polymeric material of the composite material used is a thermoplastic resin, the temperature and pressure profile firstly provides that the temperature of the thermoplastic resin is raised, from a room temperature value, up to its vitreous transition temperature. At such a temperature the thermoplastic resin melts, giving a plastic consistency to the composite material that takes up, under pressure, the shape of the mold. A second cooling step of the mold then follows during which the thermoplastic resin, cooling down, regains the desired rigidity. The mold is then opened and the pedal crank 100, 200 is removed.

In a preferred manner, inserts without a through hole, of the type shown for example in FIG. 2, instead of the inserts with the hole 6, 56, 76, 86 are positioned inside the mold. Thus all of the necessary holes 6, 56, 76, 86 are made in a subsequent step after the removal of the pedal crank from the mold. Such a step advantageously allows the correct centering of such holes 6, 56, 76, 86 to be made and allows the correct assembly of the toothed crowns, of the pin of the pedal and the correct and aligned coupling of the pedal crank 100, 200 with the bottom bracket.

Preferably, as stated above, the polymeric material with which the body of the pedal crank 100, 200 is made is the same as the polymeric material used for making the inserts 1, 20, 50, 70, 80. In such a way, the thermal coefficients of the parts that are co-molded, i.e. the body of the pedal crank 100, 200 and the inserts 1, 20, 50, 70, 80, are substantially the same and the coupling between the pedal crank and the inserts has maximum adhesion.

1. Insert for a bicycle pedal crank wherein the insert comprises unidirectional structural fibers incorporated in a polymeric material and coupled according to at least two distinct directions and wherein the insert comprises a connection portion to a part of the bicycle and a fastening portion to the body of the pedal crank.

2. Insert according to claim 1, wherein said unidirectional fibers are incorporated in at least two distinct sheets, each sheet containing fibers oriented in a single direction.

3. Insert according to claim 1, wherein said unidirectional fibers are woven together and are incorporated in a single sheet of fabric.

4. Insert according to claim 3, wherein said unidirectional fibers are oriented in two directions and constitute warp and weft of said sheet of fabric.

5. Insert according to claim 2, wherein the insert comprises a plurality of piled up sheets.

6. Insert according to claim 5, wherein said sheets are piled up staggered apart, so as to form a structure containing unidirectional structural fibers oriented in many directions.

7. Insert according to claim 5, wherein said sheets are piled up in an ordered manner, so as to form a structure containing unidirectional structural fibers oriented substantially in only two directions.

8. Insert according to claim 7, wherein said two directions substantially define a right angle.

9. Insert according to claim 3, wherein the insert comprises a plurality of piled up sheets.

10. Insert according to claim 9, wherein said sheets are piled up staggered apart, so as to form a structure containing unidirectional structural fibers oriented in many directions.

11. Insert according to claim 9, wherein said sheets are piled up in an ordered manner, so as to form a structure containing unidirectional structural fibers oriented substantially in just two directions.

12. Insert according to claim 11, wherein said two directions substantially define a right angle.

13. Insert according to claim 4, wherein said unidirectional structural fibers have equal percentage by weight of warp and weft.

14. Insert according to claim 1, wherein said unidirectional structural fibers are chosen from the group consisting of carbon fibers, glass fibers, aramidic fibers, boron fibers, ceramic fibers and combinations thereof.

15. Insert according to claim 1, wherein said polymeric material is a thermo-setting resin.

16. Insert according to claim 1, wherein said polymeric material is a thermoplastic resin.

17. Fastening portion according to claim 1, wherein the insert has a substantially elongated shape along a main axis in which said connection portion is contiguous to said fastening portion along said main axis.

18. Fastening portion according to claim 17, wherein said fastening portion has a length greater than or equal to the length of said connection portion.

19. Insert according to claim 17, wherein said fastening portion has a thickness substantially the same as a thickness of said connection portion.

20. Fastening portion according to claim 17, wherein said fastening portion has a width smaller than a width of said connection portion.

21. Insert according to claim 17, wherein said fastening portion has a thickness smaller than a thickness of said connection portion.

22. Fastening portion according to claim 20, wherein said connection portion and said fastening portion are connected through a surface comprising a circular profile.

23. Insert according to claim 1, wherein the insert has a body substantially tubular in shape, said connection portion being internally defined on said tubular body and said fastening portion being externally defined on said tubular body.

24. Insert according to claim 1, wherein said fastening portion comprises, on an outer peripheral surface, one or more depression zones.

25. Insert according to claim 24, wherein said depression zones extend for an entire thickness of said fastening portion.

26. Insert according to claim 1, wherein said fastening portion comprises a through hole.

27. Insert according to claim 26, wherein said through hole extends along the thickness of said fastening portion.

28. Insert according to claim 1, wherein said connection portion has at least one through hole.

29. Insert according to claim 28, wherein said at least one through hole is threaded.

30. Pedal crank of a bicycle, wherein the crank comprises a main body at least partially comprising a composite material comprising structural fibers incorporated in a polymeric material, and at least one insert according to claim 1.

31. Pedal crank according to claim 30, wherein said polymeric material of said composite material is substantially of the same type as the polymeric material of said insert.

32. Pedal crank according to claim 30, comprising a plurality of inserts arranged in attachment zones of said pedal crank and a toothed crown of the bicycle.

33. Pedal crank according to claim 32, wherein a thickness of said fastening portion is less than a thickness of the portion of pedal crank to which it is fastened.

34. Pedal crank according to claim 30, wherein said at least one insert is arranged in a zone of said pedal crank of attachment to a spindle of a pedal of the bicycle.

35. Pedal crank according to claim 30, wherein said at least one insert is arranged in the zone of said pedal crank of attachment to the bottom bracket of the bicycle.

36. Method for making an insert for a bicycle pedal crank of unidirectional structural fibers incorporated in a polymeric material, oriented according to at least two distinct directions, wherein the method comprises the steps of:
providing a shaped mold;
providing said unidirectional structural fibers incorporated in a polymeric material in sheets;
arranging, in said mold, a plurality of piled up sheets so that the unidirectional structural fibers are oriented according to at least two distinct directions;
subjecting the mold to a pressure and temperature profile such as to cause the setting of the polymeric material;
removing the insert from said mold.

37. Method according to claim 36, wherein said step of providing said unidirectional structural fibers incorporated in a polymeric material in sheets comprises the step of weaving said unidirectional fibers together incorporating them in a single sheet of fabric.

38. Method according to claim 36, wherein said step of arranging a plurality of piled up sheets in said mold takes place in an ordered manner, so as to form a structure containing unidirectional structural fibers oriented substantially in only two directions.

39. Method according to claim 36, wherein said step of arranging a plurality of piled up sheets in said mold provides for angularly staggering said sheets, so as to form a structure containing unidirectional structural fibers oriented in many directions.

40. Method according to claim 36, wherein the method comprises a further step of making a hole in said insert.

41. Method according to claim 40, wherein said hole is made by suitably shaping said sheets before setting of the polymeric material.

42. Method according to claim 40, wherein said hole is made after removal of said insert from said mold.

43. Method according to claim 36, wherein said mold is provided shaped according to the desired outer profile of said insert.

44. Method according to claim 36, wherein the method comprises a further step of mechanical removal after setting of the polymeric material to shape the insert according to the desired outer profile.

45. Method for making a pedal crank comprising a main body at least partially comprising a composite material comprising structural fibers incorporated in a polymeric material, wherein the method comprises the steps of:
providing a mold shaped according to the desired outer profile of the pedal crank;
providing, in at least one predetermined zone of said mold, at least one insert formed from unidirectional structural fibers incorporated in a polymeric material, coupled according to at least two distinct directions, and having a fastening portion and a connection portion;
providing said composite material in the mold;
subjecting said composite material to a temperature and pressure profile such as to allow it to be arranged in contact with the fastening portion of said at least one insert and such as to cause the setting of the polymeric material;
removing the pedal crank from the mold.

46. Method according to claim 45, further comprising the step of making a through hole in said connection portion of said insert.

47. An insert for a bicycle crank, the insert comprising a first end for coupling to a bicycle component and a second end for coupling to a bicycle crank, wherein the insert comprises unidirectional structural fibers oriented in at least two distinct directions incorporated in a polymeric material.

48. The insert of claim 47, wherein the unidirectional structural fibers incorporated in the polymeric material comprise at least two sheets, each of the sheets having the fibers oriented in a single direction.

49. The insert of claim 47, wherein the unidirectional structural fibers incorporated in the polymeric material comprise a single sheet and the fibers are interwoven.

50. The insert of claim 47, wherein the fibers are selected from the group consisting of carbon fibers, glass fibers, aramidic fibers, boron fibers, ceramic fibers and combinations thereof.

51. The insert of claim 47, wherein the first end comprises an aperture for coupling to a bicycle component.

52. The insert of claim 51, wherein the bicycle component is a pedal.

53. The insert of claim 51, wherein the bicycle component is a bottom bracket.

54. The insert of claim 51, wherein the bicycle component is a chain ring.

55. The insert of claim 47, wherein the second end comprises a fastening portion having an outer peripheral surface comprising at least one indentation.

56. The insert of claim 55, wherein the at least one indentation extends for an entire thickness of the fastening portion.

57. The insert of claim 47, wherein the second end comprises a fastening portion having a threaded through hole.

58. An insert for a bicycle crank, the insert comprising a substantially tubular body, and a fastening portion matingly engagable with a bicycle crank portion, wherein the insert is comprised of unidirectional structural fibers oriented in at least two distinct directions incorporated in a polymeric material.

59. The insert of claim 58, wherein the fastening portion further comprises grooves extending on an outer periphery of the tubular body substantially along an entire length of the insert.

60. The insert of claim 58, wherein the insert further comprises a through aperture that connects to a bicycle component.

61. The insert of claim 60, wherein the component is a bottom bracket spindle.

62. The insert of claim 60, wherein the component is a pedal.

63. An insert for a bicycle crank, the insert comprising a portion matingly engagable with a bicycle crank, the insert having a through aperture for coupling to a bicycle component, wherein the insert is comprised of unidirectional structural fibers oriented in at least two distinct directions incorporated in a polymeric material.

64. An insert for a bicycle crank, the insert comprising a portion matingly engagable with a bicycle crank, the insert having a through aperture for coupling to a bicycle component, wherein the insert is comprised of unidirectional structural fibers oriented in at least two distinct directions woven together and are incorporated in a single sheet of fabric and constitute warp and weft of said sheet of fabric, the fibers incorporated in a polymeric material.

65. An insert for a bicycle crank, the insert comprising a portion matingly engagable with a bicycle crank, the insert having a through aperture for coupling to a bicycle component, wherein the insert is comprised of unidirectional structural fibers oriented in at least two distinct directions woven together and are incorporated in a single sheet of fabric and constitute warp and weft of said sheet of fabric, the fibers incorporated in a polymeric material and have equal percentage by weight of warp and weft.

66. A pedal crank for a bicycle, wherein the crank comprises a main body at least partially comprising a composite material comprising structural fibers incorporated in a polymeric material and in that it comprises at least one insert comprising a portion matingly engagable with a bicycle crank, the insert having a through aperture for coupling to a bicycle component and wherein said polymeric material of said composite material is substantially of the same type as the polymeric material of said insert.

67. A pedal crank for a bicycle, wherein the crank comprises a main body at least partially comprising a composite material comprising structural fibers incorporated in a polymeric material and in that it comprises at least one insert comprising a portion matingly engagable with a bicycle crank, the insert having a through aperture for coupling to a bicycle component and wherein the crank comprises a plurality of inserts arranged in attachment zones of said pedal crank that attach the crank to a toothed crown of the bicycle and wherein the thickness of said fastening portion is smaller with respect to the thickness of the portion of pedal crank to which it is fastened.

68. An insert for a bicycle crank, the insert comprising a portion matingly engagable with a bicycle crank, the insert having a through aperture for coupling to a bicycle component, wherein the insert is comprised of unidirectional structural fibers and randomly arranged structural fibers, at least one of said unidirectional structural fibers and said randomly arranged structural fibers being incorporated in a polymeric material.

69. The insert of claim 68, wherein the unidirectional structural fibers are incorporated in at least two distinct sheets.

70. The insert of claim 68, wherein the randomly arranged structural fibers are incorporated in at least two distinct sheets.

71. The insert of claim 68, wherein said unidirectional structural fibers and said randomly arranged structural fibers are both incorporated in the polymeric material.

72. The insert of claim 68, wherein the fibers are selected from the group consisting of carbon fibers, glass fibers, aramidic fibers, boron fibers, ceramic fibers and combinations thereof.

73. The insert of claim 68, wherein the bicycle component is a pedal.

74. The insert of claim 68, wherein the bicycle component is a bottom bracket.

75. The insert of claim 68, wherein the bicycle component is a chain ring.

76. The insert of claim 68, wherein the matingly engagable portion comprises at least one indentation.

77. The insert of claim 68, wherein the matingly engagable portion (54) comprises an outer peripheral portion that is threaded.

78. A method of making an insert for a bicycle pedal crank, comprising the steps of:
a) providing two mold halves;
b) arranging a plurality of sheets of interwoven unidirectional structural fibers incorporated in a polymeric material within one of the mold halves so that the unidirectional structural fibers are oriented according to at least two distinct directions;
c) closing the mold halves together;
d) applying sufficient heat and pressure to the mold to cause the polymeric material to set; and
e) removing the insert from the mold.

79. A method of making an insert for a bicycle pedal crank, comprising the steps of:
a) providing a mold;
b) introducing unidirectional structural fibers and randomly arranged structural fibers into the mold, at least one of said unidirectional structural fibers and said randomly arranged structural fibers being incorporated in a polymeric material;
c) applying sufficient heat and pressure to the mold to cause the polymeric material to set; and
d) removing the insert from the mold.

80. An insert for a bicycle pedal crank produced by the process of:
a) providing two mold halves;
b) arranging a plurality of sheets of interwoven unidirectional structural fibers incorporated in a polymeric material within one of the mold halves so that the unidirectional structural fibers are oriented according to at least two distinct directions;
c) closing the mold halves together;
d) applying sufficient heat and pressure to the mold to cause the polymeric material to set; and
e) removing the insert from the mold.

81. An insert for a bicycle pedal crank produced by the process of:
a) providing a mold;
b) introducing unidirectional structural fibers and randomly arranged structural fibers into the mold, at least one of said unidirectional structural fibers and said randomly arranged structural fibers being incorporated in a polymeric material;
c) applying sufficient heat and pressure to the mold to cause the polymeric material to set; and
d) removing the insert from the mold.

82. A method of making a bicycle crank, comprising the steps of:
a) providing a mold;
b) arranging at least one insert formed from unidirectional structural fibers oriented in at least two distinct directions incorporated in a polymeric material in a portion of the mold;
c) introducing a polymeric material having randomly arranged structural fibers into the mold;
d) applying sufficient heat and pressure to the mold to cause the polymeric material to set; and
e) removing the crank from the mold.

83. Insert for a bicycle pedal crank wherein the insert comprises unidirectional structural fibers, having equal percentage by weight of warp and weft, incorporated in a thermoplastic resin, the fibers coupled according to at least two distinct directions and wherein the insert comprises a connection portion to a part of the bicycle and a fastening portion to the body of the pedal crank.
